(19) United States
(12) Patent Application Publication
(10) Pub. No.: US 2003/0033370 A1
(43) Pub. Date: Feb. 13, 2003

(54) Media-related content personalization

(76) Inventor: Nicholas Trotta, San Francisco, CA (US)

Correspondence Address: PILLSBURY WINTHROP, LLP, P.O. BOX 10500, MCLEAN, VA, 22102, US

(21) Appl. No.: 09/924,953

(22) Filed: Aug. 7, 2001

(51) Int. Cl. G06F 17/00

(52) U.S. Cl. 709/204

(57) ABSTRACT

A client side transaction collection system is able to interface with applications that users use to interact (play, access, organize, find, or share) with local media such as video and audio files. This transaction collection system contains pieces for interacting the applications and a single module for managing the push of collected transactions to an external system. A server-side system is able to take from client software, website systems, or external collection systems information about user interaction with media (play, access, organize, finding, or sharing). This system is able to take the collected information and use it to update an extremely rich user profile describing past user interactions in a useful form. The process for this involves detailed archival of information, recognition of target media, updates to rolling recent activity information, and additions to aggregated interest data based on affected categories.

### BACKGROUND OF THE INVENTION

1. Field of the Invention

The present invention is directed to information processing systems. More particularly, the invention is directed to systems that are able to robustly categorize information and perform personalization based on detailed information about users' interactions with and interests in digital video and audio media.

2. Background of the Related Art

There is currently no service that is able to perform complete personalization of content for users based on a dynamic combination of rich media-interaction and media-interest user profiles and a complete categorization web of content.

### SUMMARY OF THE INVENTION

The present invention provides a personalization system that is able to take as input a complete user profile with associated user groupings and a system that provides access to complex content categorization information. The system then dynamically assembles a processing path for analysis, executes said path, and returns the set of content from the categorization system appropriate for the specific user, grouped and categorized by importance and potential interest levels for the user.

### BRIEF DESCRIPTION OF THE DRAWINGS

These and other aspects of an embodiment of the present invention are better understood by reading the following detailed description of the preferred embodiment, taken in conjunction with the accompanying drawings, in which:

FIG. 1 is a flowchart of the process for categorizing content within the system;

FIG. 2 is a flowchart of the process for assembling a dynamic processing tree for personalization calculations;

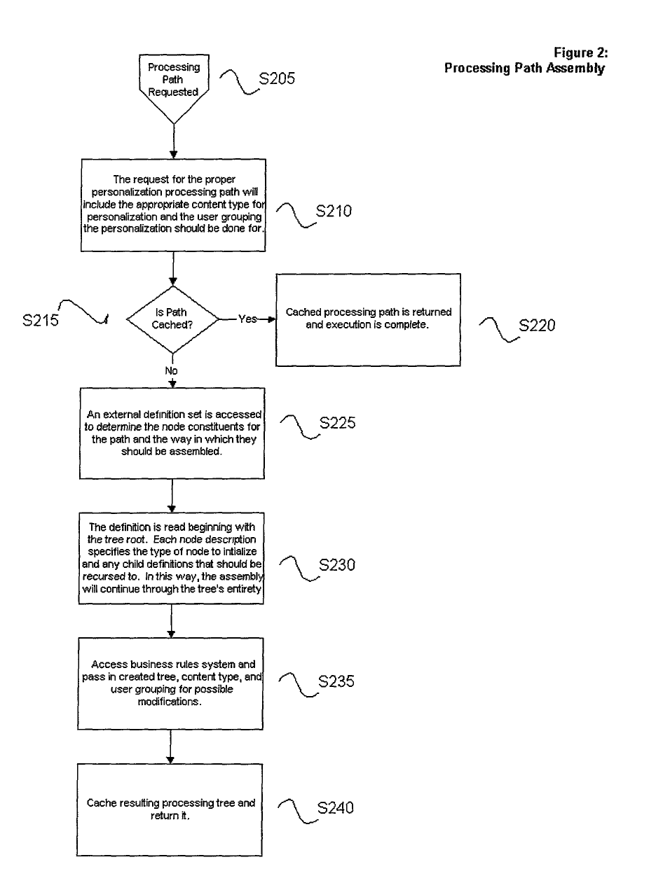

FIG. 3 is a flowchart of the process for using a business rule system to alter and augment the processing tree;

FIG. 4 is a flowchart of one section of the personalization process; and

FIG. 5 is a flowchart of one section of the personalization process.

### DETAILED DESCRIPTION OF EXEMPLARY EMBODIMENT

A preferred embodiment of the present invention provides a unique methodology for personalizing media-related content delivery to users based on a rich user profile of past user interaction. This personalization methodology involves a method for categorizing content with respect to media classification information; a method for representing a user's history of interaction with media and the users' implied interests in media as a result; and a method for determining potentially interesting content for a user by examining the entirety of a recorded user interest profile with respect to categorized content information.

A fundamental requirement for all of these techniques is the availability of an underlying classification database that describes available media. In this context, media refers to audio and/or video content. Such a classification database will describe the categorization relationships between different pieces of media. As an example, for audio content such a database will define titles for individual songs (the media), and the relationships between these songs and albums, artists, and genres. For video content, such a database would define titles for videos, and the relationships between videos, actors, directors, production companies, and release information.

“Content” as used in the descriptions of these techniques refers to auxiliary information that is related in some way to the media in the classification database. This auxiliary information can take the form of news articles, concert dates, release information, recommendations, merchandise, auctions, suggested web content, etc. As an example, a news article about a musical artist would be considered “content”, while the name of that artist and the titles of their previously released albums would be classification information from the classification database.

The first technique in the preferred embodiment is a method for categorizing content with respect to the classification database. The system for doing this has been designed to be content-type independent as much as possible, and to facilitate exact types of relationships and strength of relationships between content and the media. The uniqueness of this technique lies in the way in which it represents and maintains these relationships.

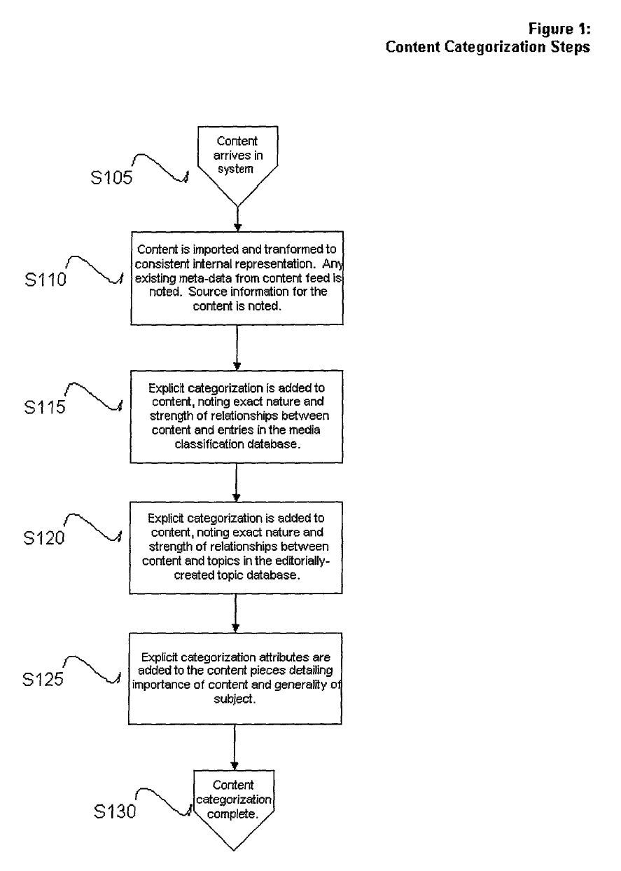

The first step of the content categorization process is for the system to acquire content to be classified (FIG. 1, S105). Such content can enter the system through any type of importation mechanism. What is important is that all content of a particular type be converted to a standardized internal representation, independent of source. This means that although content may come into the system from a myriad of formats and a variety of sources, it should be represented in the same format (S110). XML may be such a format. During this import/transformation process, any existing meta-information that will aid in classification of the information should be preserved. Information to be preserved might include the title of the content or names of people associated with the content, and would have been provided as part of the source feed for the content.

The next step of the content categorization process is for the system to note relationships between individual pieces of content and items in the media classification database (S115). At this point the system is given input (from a human or automated system) as to which individual items in the classification database the content item relates, and a corresponding entry is created for each of these relationships somewhere in a persistent content-relationship database. This entry will define: a reference to the row and table in the classification database that is the target of the relationship; a reference to the exact content item in question; a description of the type of relationship; and an indicator of the strength of the relationship (a numeric indication).

The next step of the content categorization process is for the system to note relationships between individual pieces of content and topic classifications (S120). Topic classifications are subject categories that can relate to content as previously editorially defined. They provide a way to assign and note arbitrary additional groups of classifications to content that may not be defined within the preexisting classification database. An example of this would be a subject category “2001 Academy Awards” that might be applied to news stories about nominated movies. These classifications are noted in a persistent content-relationship database. Each relationship of this type will define: a reference to the row and table in the editorial categories database that is the target of the relationship; a reference to the exact content item in question; a description of the type of relationship; and an indicator of the strength of relationship (a numeric indication).

The final step in content categorization is to exactly denote indicators for individual content pieces that will define their exact importance and the generality of their content (S125). There are two indicators here (both numeric). The first defines how “important” the individual content piece is in its entirety. This is an importance irrespective of other relationships that have been noted for the content, and is a purely editorial decision. The second indicator defines how “specific” or “general” the subject of the individual content piece is. This is a generality indicator irrespective of other relationships that have been noted for the content, and is a purely editorial decision.

After these content relationships have been noted (S130), the system exposes the relationships for query in two directions. For any content piece, the system will return the relationships attached to it, and thus media and topics that the content is related to. For any media from the classification database, or any editorially defined topic, the system will return all content to which there is a relationship, along with the strength of the relationship or relationships.

The second component in the preferred embodiment is a method for quickly accessing usefully compressed information about a user's past interaction with media. Information returned by such a system can be used to derive information about a user's possible interests in categories or topics.

Such a system can take as input any information about users' interactions or interests in media. Examples of input activity to this system could include: information about media that a user searched for or attempted to locate; information about click paths that a user took through a website; information about media that a user has played on a remote machine; information about media that a user has streamed from a server; information about items a user has purchased or paid for access to in the past (purchase history); and explicit interest information that a user may have given to a remote machine. At input to such a system, this information is stored in a persistent manner (in a database) in such a relational way as to support the following application program interface (API) for accessing it back. This API allows the calling application or module to get information about a users' past activity and interests in a useful fashion. The underlying database structure for storing the persistent information is transparent to the caller of the API.

For purposes of this API, the notion of “categorized interest” refers to either: a row within the previously described classification database referencing a single instance of a given type of classification (such as “Genre: Smooth Jazz”); or a row within the editorially-created topic database defining an editorial topic (such as “The 2001 Academy Awards”).

One set of information that can be accessed through the system API is designed to answer questions such as: “What set of categories has a user interacted with recently?”. A query of this type will include as dynamic criteria:

1) An identifier for a single user to search for.

2) A time period representing the window for which recent category interaction should be retrieved. Such a time period may be something such as “the last 24 hours”.

When queried, the system will internally hit recent activity tables that hold information about recorded user behavior that has an activity timestamp that falls within the specified time window. The returned information will include a list of specific categories of information that the user interacted with. For each category the user interacted with,

1) The type of recorded interaction (e.g., “search”, “media play”, “share”, etc.).

2) The recorded time stamp of interaction.

c) The strength of interaction as specified when the action was input to the system.

A second set of information that can be accessed through the system API is designed to answer questions such as: “What set of categories does a user seem to be interested in?”. A query of this type will include as dynamic criteria:

1) An identifier for a single user to search for.

2) An optional filter for the specific type of category to be examined: this might be something such as “Genre” or “Movie Title”.

3) A minimum level of recorded interaction strength that an interest item must achieve in order to be included in the return set.

When queried, the system will internally hit recent activity tables that hold information about recorded user behavior that has an activity timestamp that falls within the specified time window. The returned information will include a list of specific categories of information that the user is seen to be interested in due to the entirety of historically-noted interactions and behavior. For each category of information the user is seen to be interested in:

1) The types of interactions that led to the assumption of interest (e.g., “search”, “media play”, “share”, etc.).

2) The aggregate strength of interest as determined by the entirety of noted user interactions related to the interest.

3) A timestamp indicating the last time that an interaction related to a specific interest was recorded.

For optimal performance, the query system should make efficient and liberal use of caching, preferably on the side of the querying application, but this can also be done at the database level. Such caching will eliminate disk access for these queries and allow large numbers of said queries to occur in parallel extremely fast.

The final system is one that is capable of doing personalization: it is able to combine and mesh information available within the content categorization system and the user profile information interface to generate a list of content that is deemed to be interesting to a user, along with meta-information which effectively describes “why” and “how strongly” the user is thought to have interest in the content. As a requirement to implement this system, a system for doing content categorization (and accessing the results) and a system to access user profile information as described will be required.

The basis for the combinatory personalization method presented here is a personalization processing path that takes as input a user profile representation and refers both to interests in the profile and content from the categorization web during the process. The processing path itself is a tree structure. One such structure is prepared for every combination of user grouping and content type. A user grouping is an indicator for an arbitrary group of users as defined in the system and there are no size restrictions. Such a grouping is useful for defining segments of the user population based on the owner of the user or the primary properties through which they interface with the system. Content type refers to distinct types of content as supported within the system. Examples might include news, concerts, release dates, merchandise, recommendations, Internet links, etc.

The processing path itself is comprised of processing nodes. The default arrangement of processing nodes on a content type by content type basis is predefined. At runtime when the processing tree is assembled for the first time, an external definition set can be accessed to control custom placement and assignment of other nodes within the tree based on the user segment the tree is designed to handle (S225). The gathering of special nodes and path extensions make up a business rule system. This system allows for the definitions of node types to be inserted at arbitrary places in the processing tree for users of a specific grouping (S230).

The creation process for the processing tree for a combination of content type X and user grouping Y therefore is:

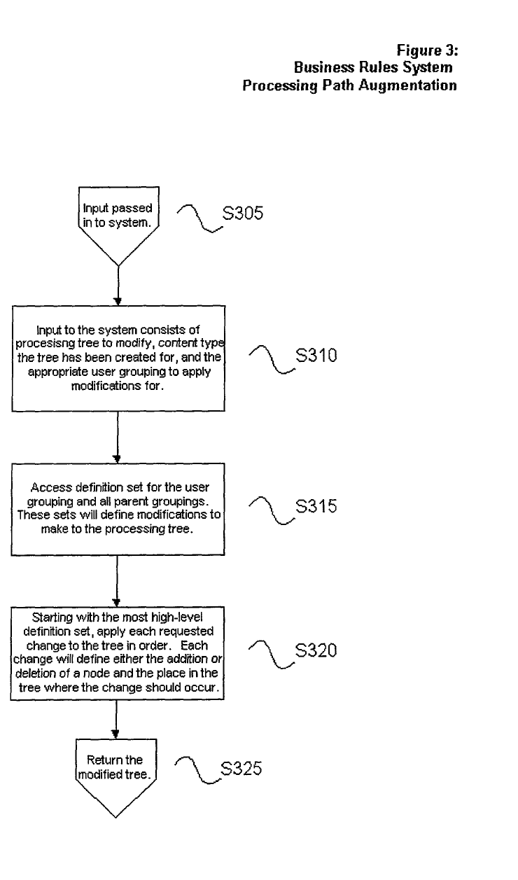

1) Based on content type X (FIG. 3, S310), fetch the default tree/node structure as persistently stored. Initialize the proper nodes and set their parents/children so as to fill out the tree structure (S225, S230, S315).

2) Access the business rule system to find additional tree modifications for user grouping Y (S235). As output from the system, receive a set of node definitions, replace/destroy/add directives, and tree placement information.

3) Apply each of the tree modifications as directed by the business rule system (S235, S320).

4) Cache the processing tree by the combination of content type X and user grouping Y for later fast access (S240).

To generate the final list of content believed to be interesting for a specific user, the system will utilize this processing path to generate the list for a specific content type. For purposes of this generation, a structure is used to hold information about the current processing state (the currently executing pass over the processing tree). This structure holds as follows:

1) A reference to the exact content item that was seen to be potentially interesting to the user and has been examined. This reference will consist of an identifier for the type of content item found and an identifier for the exact content item found.

2) A list of interest points that led to the recommendation or dismissal of the potentially interesting content item referenced by item (1). Each of these references consists of an identifier for the type of interest category and an identifier for the exact interest within the target category.

3) A set of score information (booleans and integers) that together describe the recommendation strength and reason for each of the interest points from (

2). Individual items within this set are accessible (for read/write) via a known set of “score type” identifiers. It is important to note that these “score type” identifiers can hold negative as well as positive information. For these purposes, negative information would be a reason not to recommend a content item to a user.

Each node within the processing tree is designed to take as input a potentially interesting content item from the categorization web, examine the content item and its categorization with respect to the full user profile (as can be accessed through the profile API) and then the processing state structure by adding or modifying interest references and their associated score structures. The outlying tree structure ensures that the order in which nodes process and the set of nodes available to process is held intact. There are different types of nodes made for examining different types of information within the user profile with respect to content. These different types of nodes be grouped as follows.

Profile Positive Interest Nodes

These types of nodes will first access the content categorization web and look for classifications related to the content. After finding these classifications, each type of profile positive interest node has a different aspect of the user profile it is responsible for examining. It will query against the profile API and look for the classifications related to the content. Upon finding those entries in the profile, such a node will examine the aggregate data about the relationship to the user, write an entry for this classification to the processing state structure, and then update scores for that classification based on the combination of their strength of relationship to the user profile, and their strength of relationship to the target content. As an example, a node of this type may be able to recommend a new release of the movie “Rear Window” to a user because it is categorized as relating to Alfred Hitchcock, who the user has an interest in.

Profile Negative Interest Nodes

The responsibility for these types of nodes is to examine categorization of content within the categorization web, and then query the user profile through the API for any negative relationships between the content categorizations and the user. If a negative relationship is found, that classification relationship is noted or updated within the processing state structure. The node will compare the level of negative relationship of the classification to the user profile and the level of positive relationship of the classification to the content and compare those levels against node-set thresholds. If the thresholds are reached, the content determined to not be of interest at all to the user and the offending relationship is marked as “vetoed” within the processing state. When an item is vetoed the processing for that input item stops moving through the nodes and immediately completes. As an example, a node of this type may be able to veto a merchandise item recommendation for a user because it has been categorized as relating to the recording group “Tool” who the user has expressed dislike for.

Topic Interest Nodes

These nodes will first examine the content categorization web to determine which editorially-defined topics are related to the content and how strongly they are related. These nodes will then access a list of topics the user is seen to be interested in (through a query in the profile API) and look for any correlations. If correlations are found, the node will add or update the relationship and associated score information in the processing state information. For instance, a node of this type may be to recommend a news item related to “The Simpsons” winning an Emmy because the user has expressed interest in award shows.

Profile Creation-Set Attribute Nodes

Nodes of this type will examine attributes set in a user profile (usually at the point of profile creation) and use algorithms specific to certain aspects of the content categorization web to look for user interest. Examples of these types of nodes are ones that examine the geographic location of the user, the domain of a users' email address, or the sex of a user. As an example, a node of this type may be able to recommend a concert to a user because the concert's venue is geographically close to the user's zip code.

Profile-Independent Nodes

Nodes of this type act by examining the content independent of the user profile. This means they will look at attributes explicitly set on the content and update the processing state information with new scores independent of the user profile. As an example of this, a node of this type might examine the categorized “importance” of a content item and score it higher. A node of this type might also look at the categorized “generality” score for a content item and score it lower if the item is considered extremely non-specific. A node of this type might also look at the origination date of a content piece and adjust the score of the piece higher based on how recent the item is.

Feedback Nodes

Feedback nodes are designed to take information computed outside of the personalization system and feed it back in to the personalization system such that it can affect the inclusion-outcome and scores of a content item. As an example, a feedback node could take the fact that a particular content item has been receiving large numbers of click-throughs in the system and use that to score the item more highly. A feedback node might also use the fact that a user has already viewed a content item to score that item lower or exclude it altogether. Information gleaned through other analysis mechanisms (such as prototyping) could also be fed back into the personalization system such that it could more strongly score items that seem to be of interest to a users' prototypical grouping.

Business Rules System Nodes

These are nodes whose existence and placement has been defined within the external business rules system. These nodes will be included in the processing trees for a user only if the system had deemed such nodes appropriate for the users' grouping. Such nodes often will adjust scores within the processing state information based on the source of the content. As an example, a node inserted by the business rules system may push up a score on a content piece if is from a provider that is paying to have their content emphasized within the system.

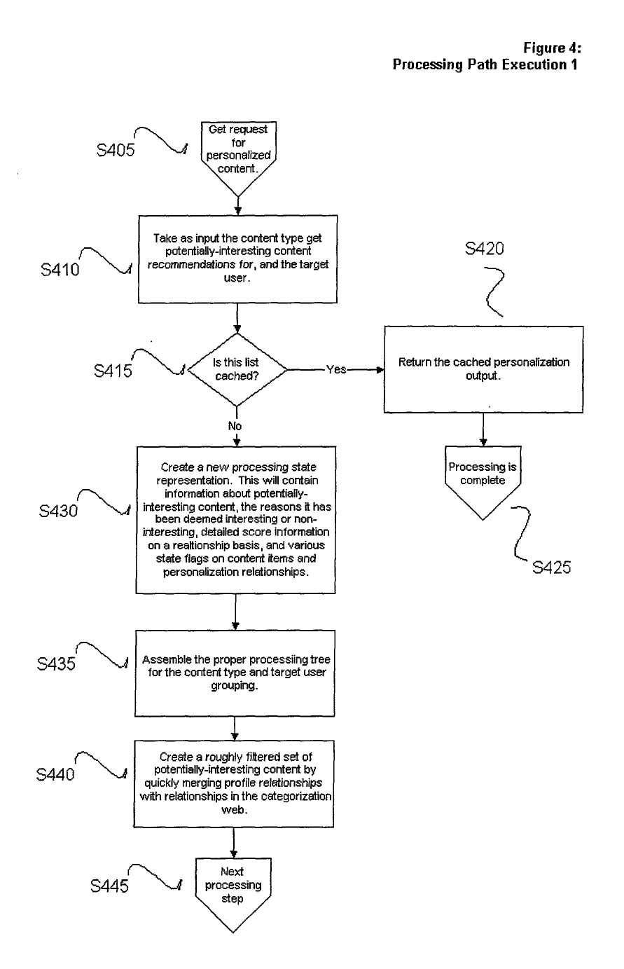

The external interfaces to the personalization system are such that a request is made to the personalization system (FIG. 4, S405) to get the set of recommended content (sorted by strength of recommendation, and including information about the reasons for recommendation) given the type of content requested (news, merchandise, concerts, recommendations, release information, etc.) and the individual user for whom to get the personalized content (S410). The actual processing steps taken for personalization within the system are as follows.

1) Check the cache to see if the set of personalized content for the user and content type in question has already been computed (S415). If so, the processing is complete and the list can be immediately returned (S420, S425).

2) If the cache is missed, a new processing state representation is created (S430).

3) The appropriate processing tree (for the user and content type) is either retrieved from cache or is assembled (S435).

4) Now an initially filtered set of content that may be of interest to the user must be generated (S440). This list is assumed to be rough, but is still likely a subset of all content within the system and therefore will save computational cycles. To get this list, the module will run a rough categorization comparison that will quickly look for all content that has any correlation between its categorizations and user interests in the classification database. For these purposes, all information about the actual nature of the categorizations and interests are completely ignored: the intention is to get a list of potentially interesting content quickly and easily. From a high-level, this is using features of the user profile to quickly scope out content of potential interest.

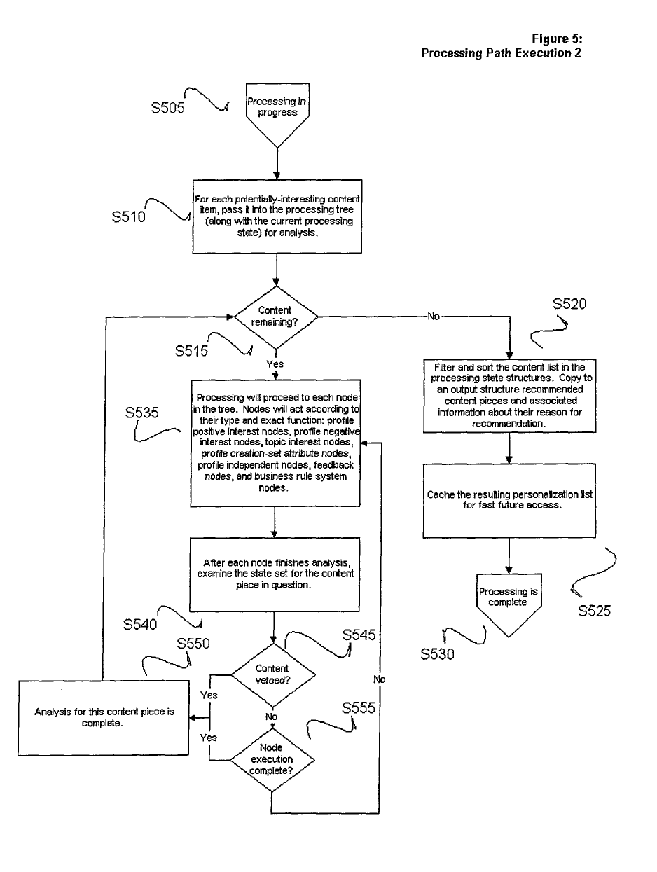

5) At this point, every individual content item of potential interest is passed into the processing tree for analysis (FIG. 5, S510). During this analysis, the processing state representation is available for update (and is persistent for the entire computation).

6) The processing will then proceed from node to node in the tree (S535). Each node will examine content categorization and profile attributes as designed and update the processing state information appropriately (S540). If any node vetoes the content, all processing on that content will cease immediately. If the content is not vetoed, processing will continue such that a node will first execute itself, than pass processing to each subsequent child node (S555).

7) After processing completes for a content item, its processing state information is added to a master list if there is a positive score in the state information.

8) After all content has been processed and all content with positive processing states are assembled, the content is sorted by comparing various scores in the state with respect to one another (S520).

9) Finally, references to content and abridged versions of the score states are copied to an output content list. This output list is cached and then returned (S525).

It should be noted that the personalization system can respond incrementally to changes in either the categorization web of content (including the availability of new content), or to changes to a user's profile.

In the event that a new piece of content is added to the categorization web, an existing personalization output can be extended simply by running the content through the appropriate processing tree and resorting the output list. In the event that an existing piece of content in the categorization web has its categorization modified in some way, that content should be removed from the output personalization list and then processed again. In the event that an existing piece of content in the categorization web is deleted, it should simply be removed from output lists.

In the event that a user updates their profile, the system should utilize the same initial filtering techniques (used to get the starting set of potentially interesting content) with respect to only those interest classifications that have been updated in the user profile. All content that meets the filter for the affected interests in the user profile should simply then be processed again.

The preferred embodiments described above have been presented for purposes of explanation only, and the present invention should not be construed to be so limited. Variations on the present invention will become readily apparent to those skilled in the art after reading this description, and the present invention and appended claims are intended to encompass such variations as well.

What is claimed is:

1. A method of processing information, the method comprising:
interfacing with a target application used to play, access, organize, find, or share digital video or audio media;
registering a change of state within the target application;
querying from the application and user environment all known details about the current state of the target application and media it is working with;
sending to another module all queried information in the form of a media interaction state message for processing.

2. The method of claim 1, further comprising detecting the change of state.

3. The method of claim 1, wherein the application state and media being acted upon are put into a message body.

4. The method of claim 1, wherein the message is sent to an external module for processing.

5. A method of processing information, the method comprising:
accepting a media interaction state message containing state information about an application used to play, access, or share digital video or audio media;
enhancing the media interaction state message by adding information uniquely identifying the current user session, machine, and time of the message;
pushing the media interaction state message up to a server in a network request;
saving media interaction state messages to disk if the machine is not connected to the network when the message is attempted to be pushed live.

6. The method of claim 5, wherein the media interaction state message is accepted.

7. The method of claim 5, wherein the media interaction state message is enhanced with user session information.

8. The method of claim 5, wherein the media interaction state message or a group of media interaction state messages are pushed up to a network device.

9. The method of claim 5, wherein a queue of unsent media interaction state messages can be saved to disk and will be sent up when it is detected that the user is back online.

10. A method of processing information, the method comprising:
accepting one or more media interaction state messages from client software, a web-serving system, or an external network system;
persistently archiving in full detail the contents of all received media interaction state messages;
identifying the media in a master database to which each media interaction state message is a reference;
notifying personalization and targeting systems of the new user transaction so that they can update and respond appropriately;
determining categorizations of the referenced media;
persistently storing the categorized information to a rolling recent activity log for the user; and
updating a persistent, compressed history of each user's interaction with the affected categorization types of the referenced media.

11. The method of claim 10, wherein one or more media interaction state messages are accepted by an interface that can communicate with client software, systems serving web pages, or external systems that are gathering information about user interests and interaction with media.

12. The method of claim 10, wherein the detailed information about captured transactions are buffered and then written out to disk in batch form for later analysis and processing.

13. The method of claim 10, wherein input information that may describe the playing media is broken into component parts and transformed into a common representation.

14. The method of claim 10, wherein transformed information is pushed against a master database of similarly transformed information describing media and the most likely match, if one exists, is determined.

15. The method of claim 10, wherein a rolling set of most recent transactions from users is updated with the information from the media interaction state.

16. The method of claim 10, wherein a rolling set of most recent transactions from users is updated with the information from the media interaction state message including user, transaction type, and categorized information from the identified target media item.

17. The method of claim 10, wherein individual persistent representation of user interests in specific categories is updated by applying the categorized information from the media interaction state message including user, transaction type, and categorized information from the identified target media item.
